(19) United States
(12) Patent Application Publication
(10) Pub. No.: US 2026/0106426 A1
(43) Pub. Date: Apr. 16, 2026

(54) CHAMBER DEVICE, GAS LASER DEVICE, AND ELECTRONIC DEVICE MANUFACTURING METHOD

(71) Applicant: Gigaphoton Inc., Tochigi (JP)

(72) Inventors: Hidenori YAMAMOTO, Oyama-shi (JP); Akihiko KUROSU, Oyama-shi (JP); Hiroyuki NOGAWA, Oyama-shi (JP); Takashi ITO, Oyama-shi (JP); Hitomi MATSUNAGA, Oyama-shi (JP); Masahide KATO, Oyama-shi (JP)

(73) Assignee: Gigaphoton Inc., Tochigi (JP)

(21) Appl. No.: 19/410,517

(22) Filed: Dec. 5, 2025

Related U.S. Application Data
(63) Continuation of application No. PCT/JP2023/027463, filed on Jul. 26, 2023.

(51) Int. Cl. H01S 3/036

(52) U.S. Cl. CPC H01S 3/036

(57) ABSTRACT

A chamber device includes a metal housing having an opening through which a laser gas and a discharge electrode are stored and which has an end portion, a ceramic electrically insulating plate having a planar shape surrounded by two sets of opposed straight edges and four corner portions, a pressing member pressing the two sets of opposed straight edges against the end portion of the opening, a groove formed to surround the opening on a receiving surface that receives the end portion of the electrically insulating plate, and an O-ring arranged in the groove. A surface of the end portion of the electrically insulating plate facing the receiving surface includes a contact surface that is in contact with the receiving surface and covers the groove, and a spaced surface that is spaced apart from the receiving surface on an outer peripheral side with respect to the contact surface.

### CROSS-REFERENCE TO RELATED APPLICATIONS

The present application is a continuation application of International Application No. PCT/JP2023/027463, filed on Jul. 26, 2023, the entire contents of which are hereby incorporated by reference.

### BACKGROUND

### 1. Technical Field

The present disclosure relates to a chamber device, a gas laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectral line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectral line width of laser light output from the gas laser device needs to be line-narrowed to the extent that the chromatic aberration can be ignored. For this purpose, there is a case in which a line narrowing module (LNM) including a line narrowing element (etalon, grating, and the like) is provided in a laser resonator of the gas laser device to line-narrow a spectral line width. In the following, a gas laser device with a narrowed spectral line width is referred to as a line narrowing gas laser device.

### LIST OF DOCUMENTS

### Patent Documents

Patent Document 1: U.S. Pat. No. 4,942,999

Patent Document 2: U.S. Pat. No. 5,028,162

Patent Document 3: Japanese Patent Application Publication No. 2001-102490

### SUMMARY

A chamber device according to an aspect of the present disclosure includes a metal housing having an opening through which a laser gas and a discharge electrode are stored, the opening having an end portion that has a stepped shape over an entire circumference thereof; a ceramic electrically insulating plate having a planar shape surrounded by two sets of opposed straight edges and four corner portions, and having a stepped end portion that is fitted with the end portion of the opening around an entire circumference so as to cover the opening; a pressing member pressing the two sets of opposed straight edges against the end portion of the opening while the four corner portions are exposed; a groove formed to surround the opening on a receiving surface that receives the end portion of the electrically insulating plate at the end portion of the opening; and an O-ring arranged in the groove. Here, a surface of the end portion of the electrically insulating plate facing the receiving surface includes, at at least one of the four corner portions, a contact surface that is in contact with the receiving surface and covers the groove, and a spaced surface that is spaced apart from the receiving surface on an outer peripheral side with respect to the contact surface.

A gas laser device according to an aspect of the present disclosure includes a chamber device, a pulse power module, and a charger. Here, the chamber device includes a metal housing having an opening through which a laser gas and a discharge electrode are stored, the opening having an end portion that has a stepped shape over an entire circumference thereof; a ceramic electrically insulating plate having a planar shape surrounded by two sets of opposed straight edges and four corner portions, and having a stepped end portion that is fitted with the end portion of the opening around an entire circumference so as to cover the opening; a pressing member pressing the two sets of opposed straight edges against the end portion of the opening while the four corner portions are exposed; a groove formed to surround the opening on a receiving surface that receives the end portion of the electrically insulating plate at the end portion of the opening; and an O-ring arranged in the groove. A surface of the end portion of the electrically insulating plate facing the receiving surface includes, at at least one of the four corner portions, a contact surface that is in contact with the receiving surface and covers the groove, and a spaced surface that is spaced apart from the receiving surface on an outer peripheral side with respect to the contact surface. The pulse power module is connected to the discharge electrode via a plurality of feedthroughs embedded in the electrically insulating plate. The charger is configured to supply a voltage to the pulse power module.

An electronic device manufacturing method according to an aspect of the present disclosure includes generating laser light using a gas laser device, outputting the laser light to an exposure apparatus, and exposing a photosensitive substrate to the laser light in the exposure apparatus to manufacture an electronic device. Here, the gas laser device includes a chamber device, a pulse power module, and a charger. The chamber device includes a metal housing having an opening through which a laser gas and a discharge electrode are stored, the opening having an end portion that has a stepped shape over an entire circumference thereof; a ceramic electrically insulating plate having a planar shape surrounded by two sets of opposed straight edges and four corner portions, and having a stepped end portion that is fitted with the end portion of the opening around an entire circumference so as to cover the opening; a pressing member pressing the two sets of opposed straight edges against the end portion of the opening while the four corner portions are exposed; a groove formed to surround the opening on a receiving surface that receives the end portion of the electrically insulating plate at the end portion of the opening; and an O-ring arranged in the groove. A surface of the end portion of the electrically insulating plate facing the receiving surface includes, at at least one of the four corner portions, a contact surface that is in contact with the receiving surface and covers the groove, and a spaced surface that is spaced apart from the receiving surface on an outer peripheral side with respect to the contact surface. The pulse power module is connected to the discharge electrode via a plurality of feedthroughs embedded in the electrically insulating plate. The charger is configured to supply a charge voltage to the pulse power module.

### BRIEF DESCRIPTION OF THE DRAWINGS

Embodiments of the present disclosure will be described below merely as examples with reference to the accompanying drawings.

FIG. 1 is a side view schematically showing the configuration of a gas laser device according to a comparative example.

FIG. 2 is a plan view showing a planar shape of an electrically insulating plate.

FIG. 3 is a plan view showing the configuration in which the electrically insulating plate and a housing are viewed from above with a pulse power module removed.

FIG. 4 is a view showing the configuration of the electrically insulating plate and the housing.

FIG. 5 is a sectional view showing a cross section along line B1-B1 of FIG. 3.

FIG. 6 is a sectional view showing a cross section along line B1-B1 of FIG. 3 when the housing and the electrically insulating plate are heated by a laser gas.

FIG. 7 is a plan view showing the configuration in which a corner portion of the electrically insulating plate is viewed from below.

FIG. 8 is a plan view showing the configuration in which the electrically insulating plate and the housing according to a first embodiment are viewed from above with the pulse power module removed.

FIG. 9 shows the configuration of the electrically insulating plate and the housing according to the first embodiment.

FIG. 10 is a sectional view showing a cross section along line B2-B2 of FIG. 8.

FIG. 11 is a sectional view showing a cross section along line B2-B2 of FIG. 8 when the housing and the electrically insulating plate are heated by the laser gas.

FIG. 12 is a plan view showing the configuration in which the corner portion of the electrically insulating plate is viewed from below.

FIG. 13 is a graph showing the dependency of a maximum value of stress applied to a boundary portion on a length of a line segment AE.

FIG. 14 is a plan view showing a modification of the planar shape of a spaced surface.

FIG. 15 is a plan view showing a modification of the planar shape of the spaced surface.

FIG. 16 is a plan view showing a modification of the planar shape of the spaced surface.

FIG. 17 is a plan view showing a modification of the planar shape of the spaced surface.

FIG. 18 is a sectional view showing a modification of the sectional shape of the spaced surface.

FIG. 19 is a sectional view showing a modification of the sectional shape of the spaced surface.

FIG. 20 is a sectional view showing a modification of the sectional shape of the spaced surface.

FIG. 21 is a plan view showing the configuration in which the electrically insulating plate and the housing according to a second embodiment are viewed from above with the pulse power module removed.

FIG. 22 shows the configuration of the electrically insulating plate and the housing according to the second embodiment.

FIG. 23 is a sectional view showing a cross section along line B3-B3 of FIG. 21.

FIG. 24 is a sectional view showing a cross section along line B3-B3 of FIG. 21 when the housing and the electrically insulating plate are heated by the laser gas.

FIG. 25 is a plan view showing the configuration in which the housing and the corner portion of the electrically insulating plate are viewed from below.

FIG. 26 is a plan view showing a modification of the planar shape of a cutout portion.

FIG. 27 is a plan view showing a modification of the planar shape of the cutout portion.

FIG. 28 is a plan view showing a modification of the planar shape of the cutout portion.

FIG. 29 is a diagram schematically showing a configuration example of an exposure apparatus.

### DESCRIPTION OF EMBODIMENTS

### Contents

1. Comparative example
   1.1 Gas laser device
      1.1.1 Configuration
      1.1.2 Operation
   1.2 Electrically insulating plate
   1.3 Problem
2. First embodiment
   2.1 Configuration
   2.2 Effect
   2.3 Modification of first embodiment
3. Second embodiment
   3.1 Configuration
   3.2 Effect
   3.3 Modification of second embodiment
4. Electronic device manufacturing method

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numeral, and duplicate description thereof is omitted.

### 1. Comparative Example

First, a comparative example of the present disclosure will be described. The comparative example of the present disclosure is an example recognized by the applicant as known only by the applicant, and is not a publicly known example admitted by the applicant.

### 1.1 Gas Laser Device

### 1.1.1 Configuration

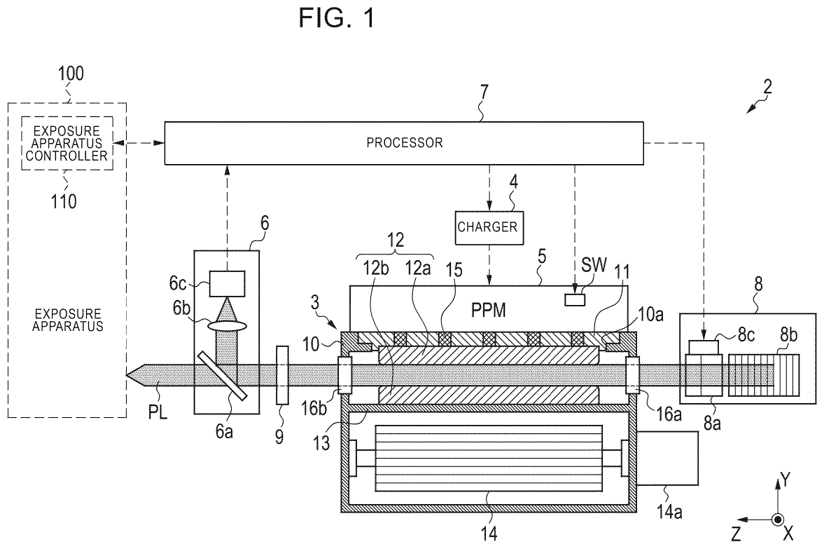

The configuration of a gas laser device 2 according to the comparative example will be described using FIG. 1. FIG. 1 schematically shows the configuration of the gas laser device 2. The gas laser device 2 is a discharge-excitation-type gas laser device that causes excitation of a laser gas by discharge, and is, for example, an excimer laser device.

In FIG. 1, the travel direction of pulse laser light PL output from the gas laser device 2 is defined as a Z direction. A discharge direction to be described later is defined as a Y direction. A direction orthogonal to the Z direction and the Y direction is defined as an X direction.

In FIG. 1, the gas laser device 2 includes a chamber device 3, a charger 4, a pulse power module (PPM) 5, a monitor module 6, a processor 7, and an optical resonator. The optical resonator is configured of a line narrowing module 8 and an output coupling mirror 9.

The chamber device 3 includes a housing 10 and an electrically insulating plate 11. An opening 10a through which the laser gas and a discharge electrode 12 are stored is formed at an upper end portion of the housing 10. For example, the chamber device 3 is a container made of metal such as aluminum plated with nickel on the surface thereof. The electrically insulating plate 11 is fixed to the housing 10 so as to block the opening 10a of the housing 10. The electrically insulating plate 11 is made of ceramics such as alumina (Al₂O₃).

The discharge electrode 12, a ground plate 13, and a fan 14 are provided inside the housing 10. Further, a laser gas containing fluorine is enclosed in the housing 10 as a laser medium. The laser gas includes, for example, argon, krypton, xenon, or the like as a rare gas, neon, helium, or the like as a buffer gas, and fluorine, chlorine, or the like as a halogen gas.

The electrically insulating plate 11 is fixed to the housing 10 so as to cover the opening 10a of the housing 10. A plurality of feedthroughs 15 are embedded in the electrically insulating plate 11. The PPM 5 is arranged on the electrically insulating plate 11. The housing 10 is grounded.

The PPM 5 is connected to the discharge electrode 12 via the feedthroughs 15. The PPM 5 includes a switch SW for causing discharge to occur at the discharge electrode 12. The charger 4 is connected to a charging capacitor (not shown) included in the PPM 5 and supplies a voltage to the PPM 5.

The discharge electrode 12 is configured of a cathode electrode 12a and an anode electrode 12b. The cathode electrode 12a and the anode electrode 12b are arranged in the housing 10 so that discharge surfaces thereof face each other. Hereinafter, the space between the cathode electrode 12a and the anode electrode 12b is referred to as a discharge space. The discharge direction is a direction in which the cathode electrode 12a and the anode electrode 12b face each other.

The cathode electrode 12a is supported by the electrically insulating plate 11 on a surface opposite to the discharge surface thereof, and is connected to the feedthroughs 15. The anode electrode 12b is supported by the ground plate 13 on a surface opposite to the discharge surface thereof.

The fan 14 is a cross flow fan for circulating the laser gas in the housing 10, and is arranged on the opposite side of the discharge space with respect to the ground plate 13. A motor 14a for rotationally driving the fan 14 is connected to the housing 10. A heat exchanger (not shown) is arranged inside the housing 10.

Side walls of the housing 10 are provided with windows 16a, 16b for outputting light generated in the housing 10 to the outside, respectively. The housing 10 is arranged such that the optical path of the optical resonator passes through the discharge space and the windows 16a, 16b.

The line narrowing module 8 may include a prism 8a, a grating 8b, and a rotation stage 8c. The prism 8a transmits the light output from the chamber device 3 through the window 16a toward the grating 8b while expanding the beam width of the light.

The grating 8b is arranged in the Littrow arrangement so that the incident angle and the diffraction angle are the same. The prism 8a is supported by the rotation stage 8c, and when the prism 8a is rotated by the rotation stage 8c, the incident angle of light on the grating 8b is changed. The grating 8b is a wavelength selection element that selectively extracts light having a wavelength near a particular wavelength in accordance with the diffraction angle. The spectral width of the light returning from the grating 8b to the chamber device 3 via the prism 8a is line-narrowed.

The output coupling mirror 9 transmits a part of the light output from the chamber device 3 through the window 16b, and reflects the other part back into the chamber device 3. The surface of the output coupling mirror 9 is coated with a partial reflection film.

Light output from the chamber device 3 reciprocates between the line narrowing module 8 and the output coupling mirror 9, and is amplified each time the light passes through the discharge space. A part of the amplified light is output as the pulse laser light PL via the output coupling mirror 9. Here, the pulse laser light PL is an example of the “laser light” according to the technology of the present disclosure.

The monitor module 6 is arranged on the optical path of the pulse laser light PL output via the output coupling mirror 9. The monitor module 6 includes a beam splitter 6a, a light concentrating optical system 6b, and an optical sensor 6c.

The beam splitter 6a transmits the pulse laser light PL with a high transmittance and reflects a part of the pulse laser light PL toward the light concentrating optical system 6b. The light concentrating optical system 6b concentrates the light reflected by the beam splitter 6a on a light receiving surface of the optical sensor 6c. The optical sensor 6c measures a pulse energy E and a wavelength λ of the light concentrated on the light receiving surface, and outputs the measurement values thereof to the processor 7.

The processor 7 is a processing device that transmits and receives various signals to and from an exposure apparatus controller 110 provided in an exposure apparatus 100. For example, the exposure apparatus controller 110 transmits, to the processor 7, a target pulse energy Et and a target wavelength λt of the pulse laser light PL to be output to the exposure apparatus 100, an oscillation trigger signal, and the like.

The processor 7 generally controls operation of components of the gas laser device 2 based on various signals transmitted from the exposure apparatus controller 110, the measurement values of the pulse energy E and the wavelength λ, and the like.

### 1.1.2 Operation

Next, operation of the gas laser device 2 according to the comparative example will be described. The processor 7 receives the target pulse energy Et, the target wavelength λt, and the oscillation trigger signal from the exposure apparatus controller 110 of the exposure apparatus 100.

The processor 7 sets the charge voltage corresponding to the target pulse energy Et in the charger 4. Then, the processor 7 operates the switch SW in the PPM 5 in synchronization with the oscillation trigger signal to apply a high voltage between the cathode electrode 12a and the anode electrode 12b. As a result, discharge occurs in the discharge space, the laser gas is excited, and laser oscillation is performed in the optical resonator. At this time, the pulse laser light PL line-narrowed by the line narrowing module 8 is output from the output coupling mirror 9.

The pulse laser light PL output from the output coupling mirror 9 enters the monitor module 6, and the pulse energy E and the wavelength λ are measured by the monitor module 6. The pulse laser light PL transmitted through the beam splitter 6a of the monitor module 6 enters the exposure apparatus 100.

The processor 7 controls the charge voltage so that the difference between the target pulse energy Et and the measurement value of the pulse energy E approaches zero. Further, the processor 7 controls the rotation stage 8c so that the difference between the target wavelength λt and the measurement value of the wavelength λ approaches zero.

Although an excimer laser device is exemplified as the gas laser device 2 in FIG. 1, the gas laser device 2 may be an F2 laser device using a laser gas including a fluorine gas and a buffer gas, or the like.

### 1.2 Electrically Insulating Plate

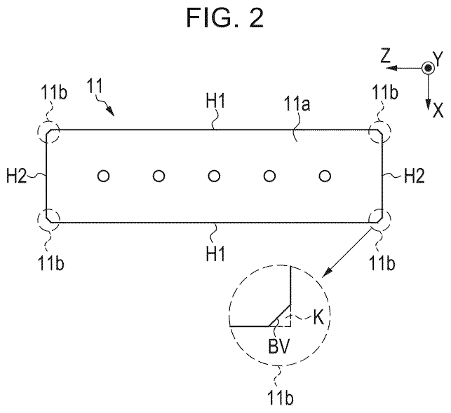

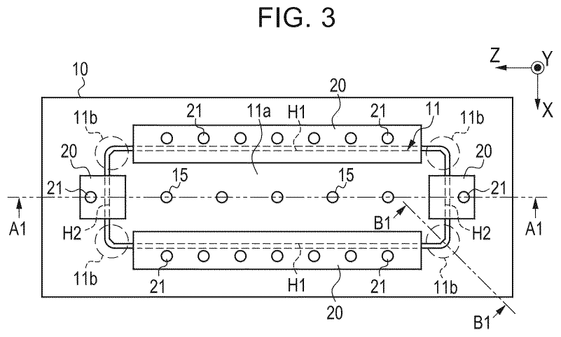

Next, the configuration of the electrically insulating plate 11 will be described. FIG. 2 shows the planar shape of the electrically insulating plate 11. FIG. 3 shows the configuration in which the electrically insulating plate 11 and the housing 10 are viewed from above with the PPM 5 removed.

An upper surface 11a of the electrically insulating plate 11 is substantially rectangular and has a planar shape surrounded by a pair of first edges H1 opposed to each other in the X direction, a pair of second edges H2 opposed to each other in the Y direction, and four corner portions 11b. The first edges H1 and the second edges H2 are each straight. The corner portions 11b connect the first edges H1 and the second edges H2. The pair of first edges H1 and the pair of second edges H2 correspond to the “two sets of opposed straight edges” according to the technology of the present disclosure.

As shown in FIG. 2, each of the corner portions 11b includes a chamfered portion BV formed by cutting off the end portion of the electrically insulating plate 11 obliquely with respect to the first edge H1 and the second edge H2. K represents a cut-off portion.

As shown in FIG. 3, the electrically insulating plate 11 is fixed in a state of being pressed against the housing 10 by using four holding plates 20 and a plurality of bolts 21. For example, the material of the pressing plates 20 is stainless steel. The four pressing plates 20 are an example of the “pressing member”according to the technology of the present disclosure.

Specifically, the four pressing plates 20 are arranged so as to cover the two sets of opposed straight edges H1, H2 in the periphery of the electrically insulating plate 11. Here, although it is desirable that the four pressing plates 20 cover the entire periphery of the electrically insulating plate 11, the four corner portions 11b are exposed without being covered for structural reasons such as that other components need to be arranged in the vicinity of the corner portions 11b of the electrically insulating plate 11. That is, the four pressing plates 20 press the two sets of straight edges H1, H2 opposed to each other against the end portion of the opening 10a while the four corner portions 11b are exposed.

The plurality of feedthroughs 15 are arranged at equal intervals in the Z direction, which is the longitudinal direction of the electrically insulating plate 11.

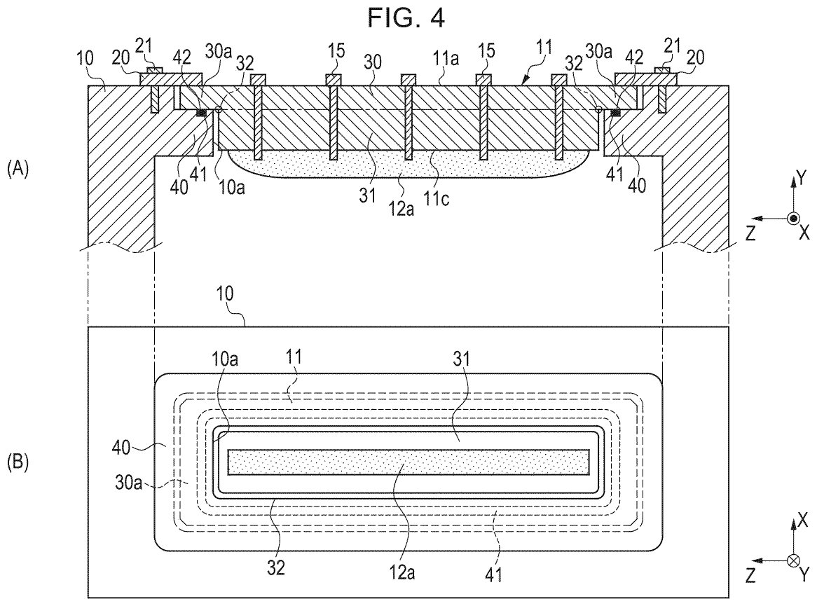

FIG. 4 shows the configuration of the electrically insulating plate 11 and the housing 10. (A) of FIG. 4 shows a cross section along line A1-A1 of FIG. 3. (B) of FIG. 4 shows the configuration in which the electrically insulating plate 11 is viewed from below.

As shown in (A) of FIG. 4, the electrically insulating plate 11 includes a base portion 30 and an electrode fixing portion 31 having a smaller planar shape than the base portion 30. The base portion 30 and the electrode fixing portion 31 are integrally formed of the above-described ceramic. The electrode fixing portion 31 is arranged on the inner side of the housing 10 with respect to the base portion 30. That is, the upper surface 11a of the electrically insulating plate 11 is the upper surface of the base portion 30. The cathode electrode 12a is fixed to a lower surface 11c of the electrically insulating plate 11, that is, to the surface of the electrode fixing portion 31.

Since the electrode fixing portion 31 has a smaller planar shape than the base portion 30, an outer edge portion 30a of the base portion 30 protrudes outward from the electrode fixing portion 31 over the entire circumference. Therefore, the end portion of the electrically insulating plate 11 is formed in a stepped shape including a boundary portion 32 between the base portion 30 and the electrode fixing portion 31.

A receiving portion 40 for receiving the electrically insulating plate 11 is formed in the housing 10. The receiving portion 40 protrudes inward from the inner wall of the housing 10 over the entire circumference. An end portion of the receiving portion 40 forms the above-described opening 10a. Therefore, the housing 10 is formed in a stepped shape to be fitted to an end portion of the stepped electrically insulating plate 11 so as to block the opening 10a. The outer edge portion 30a of the base portion 30 is in contact with the upper surface of the receiving portion 40. The outer edge portion 30a is sandwiched and fixed between the receiving portion 40 and the pressing plate 20. The electrode fixing portion 31 is arranged inside the end portion of the opening 10a.

On the upper surface of the receiving portion 40, a ring-shaped groove 41 is formed to surround the opening 10a in an XZ plane. An O-ring 42 having a cross-sectional diameter larger than the depth of the groove 41 is arranged in the groove 41 to maintain airtightness of the housing 10. The O-ring 42 is made of a metal, an elastomer, a resin, or the like. The O-ring 42 receives a pressing force from the outer edge portion 30a of the base portion 30, and seals between the upper surface of the receiving portion 40 and the outer edge portion 30a.

As shown in (B) of FIG. 4, in the XZ plane, the O-ring 42 surrounds the boundary portion 32 and the boundary portion 32 surrounds the electrode fixing portion 31.

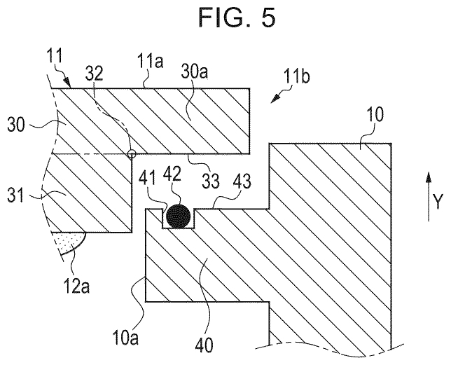

FIG. 5 shows a cross section along line B1-B1 of FIG. 3. In FIG. 5, for the purpose of explanation, the electrically insulating plate 11 is shown in a state of being separated from the housing 10 in the Y direction. Since the upper surface of the receiving portion 40 is a surface that receives the outer edge portion 30a of the base portion 30, it is hereinafter referred to as a receiving surface 43. The receiving surface 43 has a planar shape except for the groove 41. Further, since the lower surface of the outer edge portion 30a is a surface that is in contact with the receiving surface 43, it is hereinafter referred to as a contact surface 33. The contact surface 33 has a planar shape and is entirely in contact with the receiving surface 43.

### 1.3 Problem

When the gas laser device 2 is operated, the laser gas enclosed in the housing 10 becomes high in temperature, so that the housing 10 and the electrically insulating plate 11 are heated by the laser gas. The material of the housing 10 is a metal such as aluminum, while the material of the electrically insulating plate 11 is a ceramic such as alumina, so that the thermal expansion coefficient is different between the housing 10 and the electrically insulating plate 11.

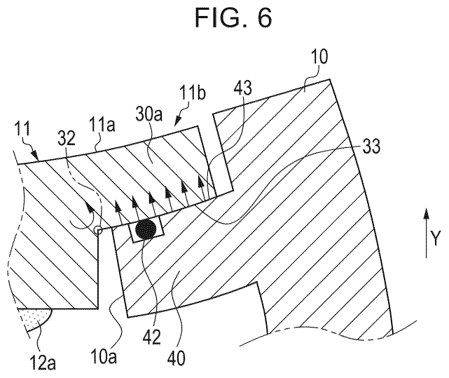

FIG. 6 shows a cross-section along line B1-B1 of FIG. 3 when the housing 10 and the electrically insulating plate 11 are heated by the laser gas. Since the thermal expansion coefficient of the housing 10 is larger than that of the electrically insulating plate 11, when the housing 10 and the electrically insulating plate 11 are heated, the contact surface 33 of the electrically insulating plate 11 receives stress in the Y direction from the receiving surface 43 of the housing 10. Since the pressing plate 20 is not arranged on the corner portion 11b of the electrically insulating plate 11, a bending moment with the boundary portion 32 being as a fulcrum is generated by the stress received by the contact surface 33. This bending moment can occur at any of the four corner portions 11b.

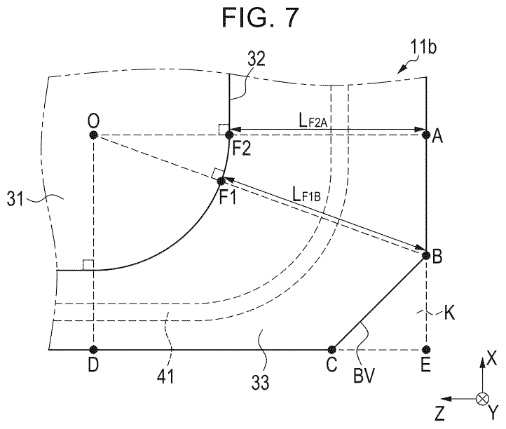

FIG. 7 shows the configuration in which the corner portion 11b of the electrically insulating plate 11 is viewed from below. In FIG. 7, the housing 10 is not shown. As shown in FIG. 7, at the corner portion 11b, the boundary portion 32 has an arc shape centered on a center point O.

In FIG. 7, A to D represent imaginary points located at an end portion of the outer edge portion 30a of the electrically insulating plate 11. E represents an intersection point where an imaginary line obtained by extending a line segment AB intersects an imaginary line obtained by extending a line segment DC. A triangle BCE corresponds to the cut-off portion K described above. A line segment BC corresponds to the chamfered portion BV described above. The positions of the imaginary points B, C are selected so that the line segment BC is not in contact with the outermost end of the groove 41. In the present comparative example, the angle of the line segment BC is set so as to intersect the X direction and the Z direction each at an angle of 45°.

The imaginary point A is located at the Z-direction end of the outer edge portion 30a. F1 represents an intersection point where a straight line connecting the center point O and the imaginary point B intersects the boundary portion 32. F2 represents an intersection point at which a straight line connecting the center point O and the imaginary point A intersects the boundary portion 32. When the distance between the intersection point F1 and the imaginary point B is defined as L_{F1B} and the distance between the intersection point F2 and the imaginary point A is defined as L_{F2A}, the relationship of L_{F1B}>L_{F2A} is always satisfied.

The magnitude of the bending moment generated at the boundary portion 32 is proportional to the distance between the boundary portion 32 and the end portion of the contact surface 33. Since the imaginary point B is farther from the boundary portion 32 than the imaginary point A, the bending moment with the imaginary point B as the point of action is always larger than that with the imaginary point A. The same applies to the relationship between the imaginary point D and the imaginary point C located at the X-direction end of the outer edge portion 30a.

Thus, the bending moment generated at the boundary portion 32 increases at the corner portion 11b of the electrically insulating plate 11. When the bending moment increases, a crack may occur at the boundary portion 32. Therefore, it is desired to reduce the bending moment generated at the boundary portion 32.

### 2. First Embodiment

### 2.1 Configuration

The gas laser device 2 according to a first embodiment of the present disclosure has a configuration similar to that of the gas laser device 2 according to the comparative example except that the configuration of the electrically insulating plate 11 is different.

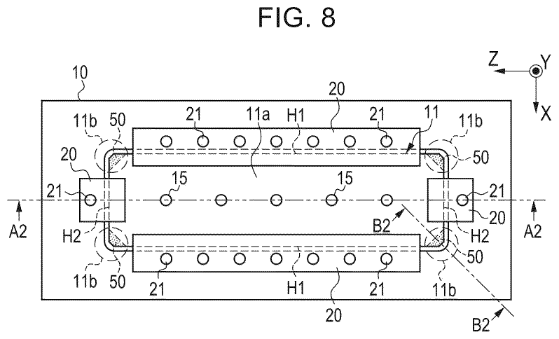

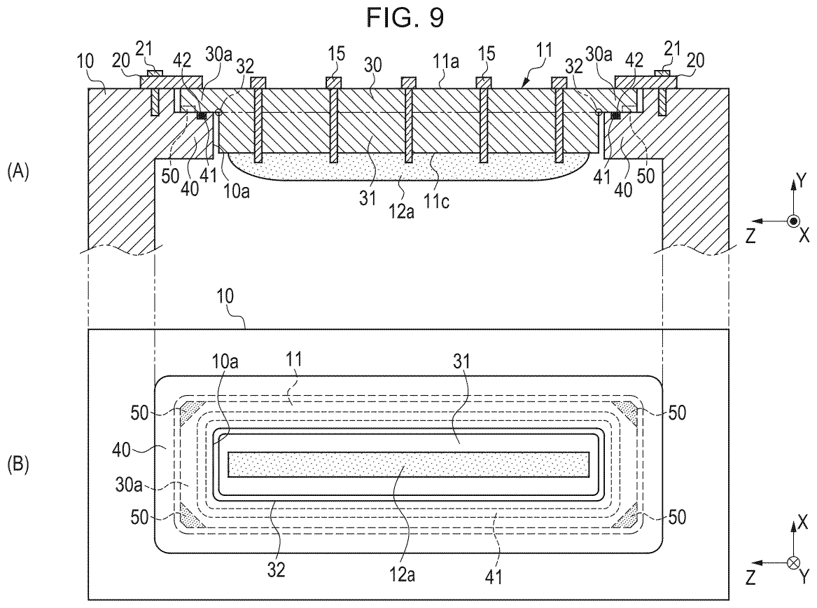

FIG. 8 shows the configuration in which the electrically insulating plate 11 and the housing 10 according to the first embodiment are viewed from above with the PPM 5 removed. FIG. 9 shows the configuration of the electrically insulating plate 11 and the housing 10 according to the first embodiment. (A) of FIG. 9 shows a cross section along line A2-A2 of FIG. 8. (B) of FIG. 9 shows the configuration in which the electrically insulating plate 11 according to the first embodiment is viewed from below. The electrically insulating plate 11 according to the first embodiment is different from that of the comparative example only in that the cutout portions 50 are formed on the lower surface side of the four corner portions 11b, respectively.

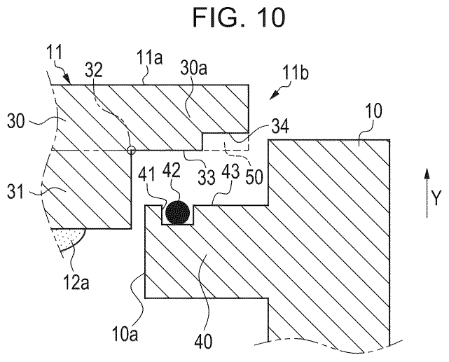

FIG. 10 shows a cross section along line B2-B2 of FIG. 8. In FIG. 10, for the purpose of explanation, the electrically insulating plate 11 is shown in a state of being separated from the housing 10 in the Y direction. The cutout portions 50 are formed in the electrically insulating plate 11 by cutting out end portions of a surface of the corner portion 11b facing the receiving surface 43 of the outer edge portion 30a. Owing to that the cutout portion 50 is formed, the electrically insulating plate 11 is formed with a spaced surface 34 spaced apart from the receiving surface 43 in the Y direction.

The spaced surface 34 is spaced apart from the receiving surface 43 on the outer peripheral side with respect to the contact surface 33. That is, the spaced surface 34 is a non-contact surface that is not in contact with the receiving surface 43. In the present embodiment, the spaced surface 34 and the receiving surface 43 are each planar, and the distance between the spaced surface 34 and the receiving surface 43 is constant. The contact surface 33 is in contact with the receiving surface 43 so as to cover the groove 41.

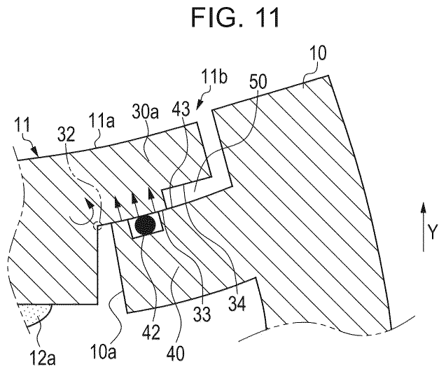

FIG. 11 shows a cross-section along line B2-B2 of FIG. 8 when the housing 10 and the electrically insulating plate 11 are heated by the laser gas. In the present embodiment, since the spaced surface 34 does not receive stress from the receiving surface 43, the magnitude of the bending moment with the boundary portion 32 being as a fulcrum is smaller than that in the comparative example. The depth of the cutout portion 50 in the Y-direction is preferably equal to or greater than a thermal deformation amount of the housing 10 so that the spaced surface 34 does not come into contact with the receiving surface 43, and is preferably equal to or greater than 0.1 mm, for example.

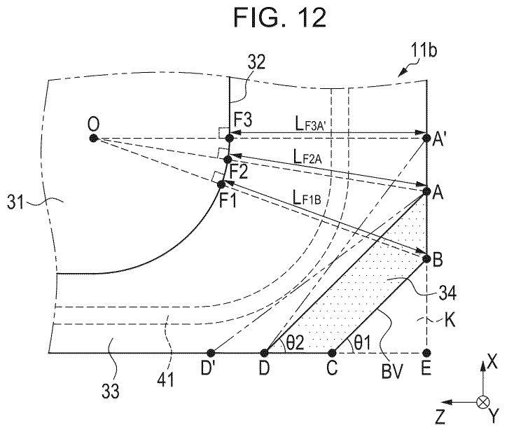

FIG. 12 shows the configuration in which the corner portion 11b of the electrically insulating plate 11 is viewed from below. The spaced surface 34 is formed between the chamfered portion BV and a region corresponding to the groove 41. The spaced surface 34 has a shape having four vertices with the chamfered portion BV being one side. For example, the spaced surface 34 is quadrilateral.

In FIG. 12, A to D represent imaginary points located at the end portion of the outer edge portion 30a of the electrically insulating plate 11. Similarly to the comparative example, the triangle BCE corresponds to the cut-off portion K described above. The imaginary point A is located at the Z-direction end of the outer edge portion 30a and is located farther from the imaginary point E than the imaginary point B. The imaginary point D is located at the X-direction end of the outer edge portion 30a and is located farther from the imaginary point E than the imaginary point C.

In the present embodiment, the region surrounded by the imaginary points A to D is the spaced surface 34. The positions of the imaginary points A, D are selected so that a line segment AD is not in contact with the outermost end of the groove 41. In the present embodiment, the line segment BC and the line segment AD are parallel to each other. Thus, the spaced surface 34 is trapezoidal. Further, an angle θ1 formed by the line segment BC and a line segment CE and an angle θ2 formed by the line segment AD and a line segment DE are equal to each other and are 45 degrees, respectively.

In the present embodiment, the line segment AD and the line segment BC are parallel, but may be non-parallel. That is, the spaced surface 34 is not limited to trapezoidal, and may be quadrilateral other than trapezoidal. For example, the spaced surface 34 may be a region surrounded by imaginary points A′, B, C, D. In this case, positions of the imaginary points A', D are selected so that the line segment A′ D is not in contact with the outermost end of the groove 41. Further, the spaced surface 34 may be a region surrounded by imaginary points A, B, C, D′. In this case, positions of the imaginary points A, D′ are selected so that the line segment AD′ is not in contact with the outermost end of the groove 41.

### 2.2 Effect

In the present embodiment, since the spaced surface 34 is formed on the electrically insulating plate 11, the longest distance between the boundary portion 32 and the Z-direction end of the contact surface 33 changes from the distance L_{F1B} between the intersection point F1 and the imaginary point B to the distance L_{F2A} between the intersection point F2 and the imaginary point A. The same applies to the relationship between the imaginary point D and the imaginary point C. As described above, in the present embodiment, by providing the spaced surface 34, the distance between the boundary portion 32 and the end portion of the contact surface 33 is reduced, so that the bending moment generated at the boundary portion 32 is reduced. This suppresses occurrence of cracks and extends the lifetime of the electrically insulating plate 11.

Here, when the spaced surface 34 is the region surrounded by the imaginary points A', B, C, D, the longest distance between the boundary portion 32 and the Z-direction end of the contact surface 33 is a distance L_{F3A′} between the intersection point F3 and the imaginary point A′, so that the distance between the boundary portion 32 and the end of the contact surface 33 becomes smaller. The same applies to the case in which the spaced surface 34 is the region surrounded by the imaginary points A, B, C, D′.

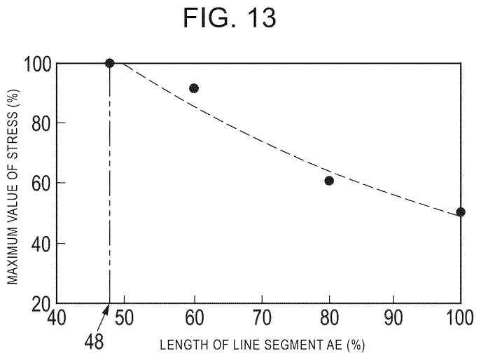

FIG. 13 shows the dependency of the maximum value of the stress applied to the boundary portion 32 on the length of the line segment AE. The stress applied to the boundary portion 32 is bending stress corresponding to the bending moment. FIG. 13 is a simulation result under conditions where θ1=θ2=45° and the depth of the cutout portion 50 in the Y direction is 0.6 mm. The length of the line segment AE is equal to the length of the line segment DE. The horizontal axis represents the largest length of the line segment AE as taking that when the line segment AD is not in contact with the outermost end of the groove 41 as 100%. The vertical axis represents the maximum value of the stress applied to the boundary portion 32, where the value in the comparative example is taken as 100%.

In the case of the comparative example, that is, when the line segment AE overlaps the line segment BC, the length of the line segment AE is 48% of the maximum length. The maximum value of the stress applied to the boundary portion 32 decreases with the increase of the length of the line segment AE. When the length of the line segment AE is 100%, that is, when the area of the spaced surface 34 is the maximum, the maximum value of the stress applied to the boundary portion 32 is suppressed to about 50%.

### 2.3 Modification of First Embodiment

Various modifications of the first embodiment will be described below.

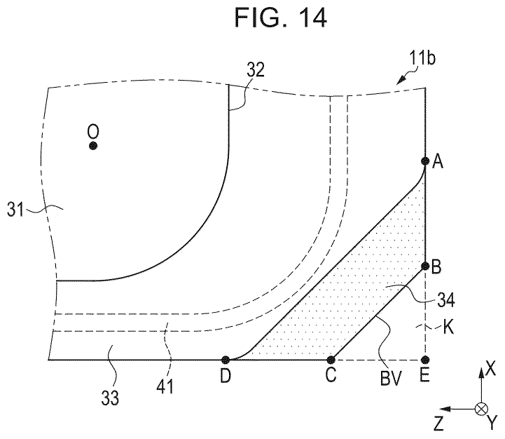

Although the spaced surface 34 is quadrilateral in the above embodiment, it may be other than quadrilateral as long as being surrounded by a line passing through four imaginary points present at the end portion of the outer edge portion 30a. For example, as shown in FIG. 14, the line segment AD may not be perfectly straight, and both ends of the straight-like line segment AD may be curved.

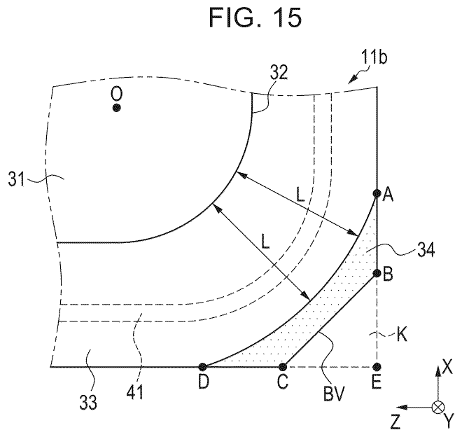

Further, as shown in FIG. 15, the line segment AD may be concavely curved toward the center point O as a whole. More specifically, the line segment AD may have an arc shape centered on the center point O. In this case, since the distance L between the boundary portion 32 and the line segment AD becomes equal at any position at the corner portion 11b, the stress applied to the boundary portion 32 at the corner portion 11b becomes uniform. As a result, stress concentration is suppressed, and thus damage to the boundary portion 32 is further suppressed.

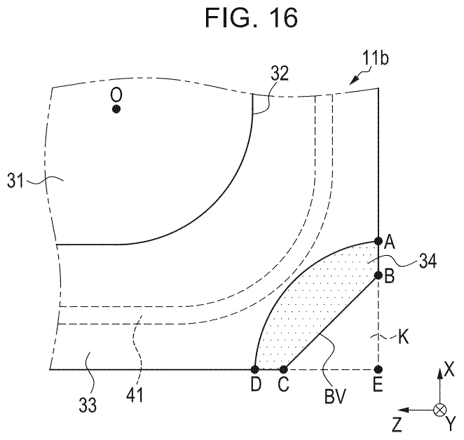

Further, as shown in FIG. 16, the line segment AD may be convexly curved toward the center point O as a whole. In this case, the line segment AD may have an arc shape having the same curvature as that of the boundary portion 32.

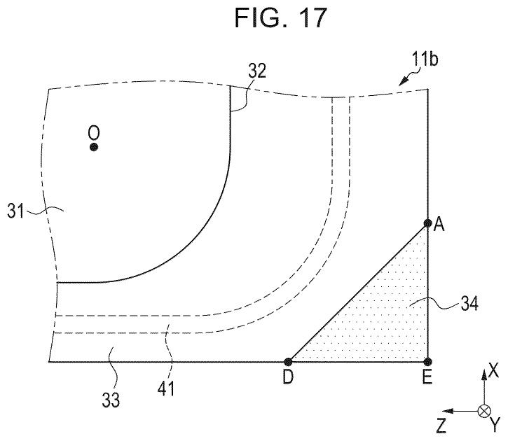

In the above embodiment, the chamfered portion BV is formed at the corner portion 11b, but the chamfered portion BV is not necessarily formed. That is, the electrically insulating plate 11 may have a rectangular shape in which the chamfered portion BV is not formed. In this case, as shown in FIG. 17, the spaced surface 34 has a shape with three vertices. Specifically, the spaced surface 34 is a triangle with the imaginary points A, D, E as vertices. The shape of the spaced surface 34 may be a right-angled triangle or a right-angled isosceles triangle. Alternatively, in this case, the spaced surface 34 may not be a triangle as long as being surrounded by a line passing through three imaginary points. The line segment AD can be modified in a similar manner as in FIGS. 14 to 16.

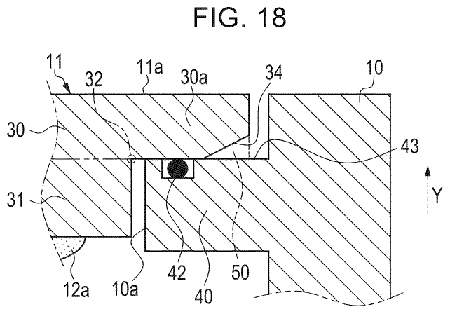

Further, although the distance between the spaced surface 34 formed in the cutout portion 50 and the receiving surface 43 is constant in the above embodiment, the cutout portion 50 may be formed such that the distance between the spaced surface 34 and the receiving surface 43 is increased toward the outer side of the outer edge portion 30a as shown in FIGS. 18 to 20. In this case, since the angle of the end portion of the contact surface 33 is increased, it is possible to suppress damage to the end portion of the contact surface 33.

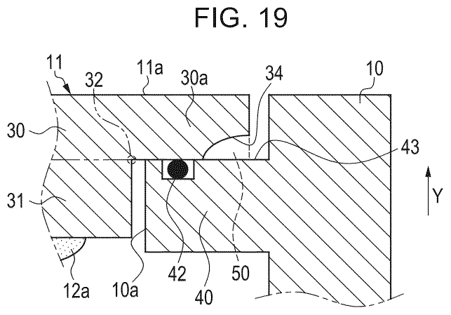

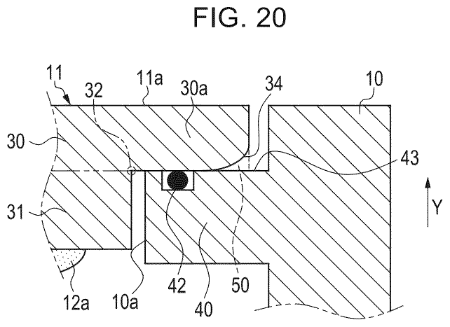

FIG. 18 shows an example in which the increase rate of the distance between the spaced surface 34 and the receiving surface 43 is constant. In this case, the spaced surface 34 is planar. FIG. 19 shows an example in which the increase rate of the distance between the spaced surface 34 and the receiving surface 43 decreases toward the outer peripheral side. In this case, the spaced surface 34 is concave. FIG. 20 shows an example in which the increase rate of the distance between the spaced surface 34 and the receiving surface 43 increases toward the outer peripheral side. In this case, the spaced surface 34 is convex.

Further, although the cutout portions 50 are formed at all of the four corner portions 11b in the above embodiment, it is sufficient to form the cutout portion 50 at at least one of the four corner portions 11b. For example, the cutout portions 50 may be formed at two of the four corner portions 11b, or the cutout portions 50 may be formed at three of the four corner portions 11b.

### 3. Second Embodiment

### 3.1 Configuration

The gas laser device 2 according to a second embodiment of the present disclosure has a configuration similar to the gas laser device 2 according to the first embodiment except that the configuration of the electrically insulating plate 11 and the housing 10 are different.

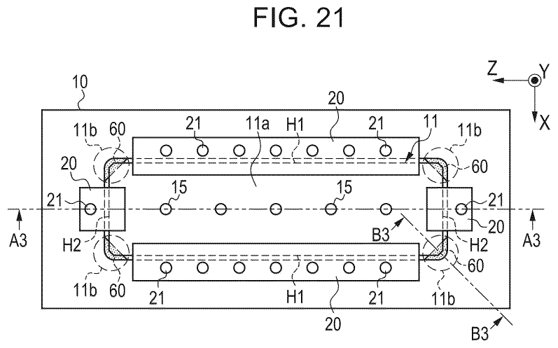

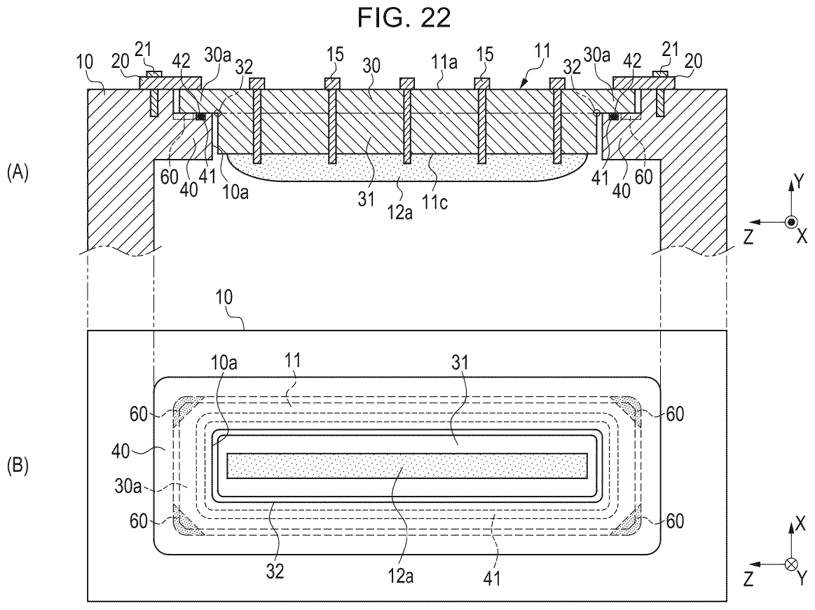

FIG. 21 shows the configuration in which the electrically insulating plate 11 and the housing 10 according to the second embodiment are viewed from above with the PPM 5 removed. FIG. 22 shows the configuration of the electrically insulating plate 11 and the housing 10 according to the second embodiment. (A) of FIG. 22 shows a cross section along line A3-A3 of FIG. 21. (B) of FIG. 22 shows the configuration in which the electrically insulating plate 11 according to the second embodiment is viewed from below.

The electrically insulating plate 11 according to the second embodiment has a configuration similar to the electrically insulating plate 11 according to the comparative example, and does not have the cutout portions 50 formed. In the present embodiment, cutout portions 60 are formed by partially cutting out regions of the housing 10 corresponding to the four corner portions 11b.

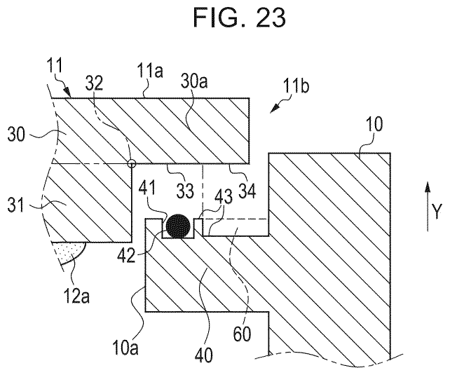

FIG. 23 shows a cross section along line B3-B3 of FIG. 21. In FIG. 23, for the purpose of explanation, the electrically insulating plate 11 is shown in a state of being separated from the housing 10 in the Y direction. Each of the cutout portions 60 is formed in the housing 10 by cutting out a part of a surface of the corner portion 11b facing the end portion of the outer edge portion 30a of the electrically insulating plate 11. Owing to that the cutout portion 60 is formed in the housing 10, the end portion of the outer edge portion 30a is spaced apart from the receiving surface 43 in the Y direction. A part of a lower surface of the outer edge portion 30a that faces the cutout portion 60 functions as the spaced surface 34. In the present embodiment, in addition to the surface on which the groove 41 is formed, a bottom surface of the cutout portion 60 is also referred to as the receiving surface 43.

Similarly to the first embodiment, the spaced surface 34 is spaced apart from the receiving surface 43 on the outer peripheral side with respect to the contact surface 33 and faces the receiving surface 43. That is, the spaced surface 34 is a non-contact surface that is not in contact with the receiving surface 43. In the present embodiment, the distance between the spaced surface 34 and the receiving surface 43 is constant. The contact surface 33 is in contact with the receiving surface 43 so as to cover the groove 41.

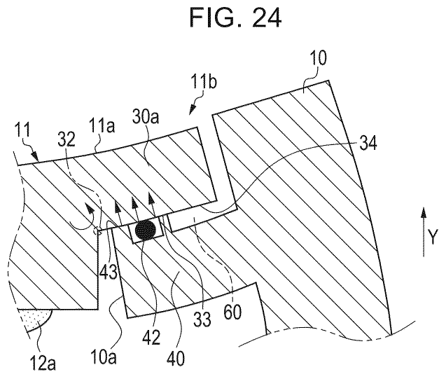

FIG. 24 shows a cross-section along line B3-B3 of FIG. 21 when the housing 10 and the electrically insulating plate 11 are heated by the laser gas. In the present embodiment, since the spaced surface 34 does not receive stress from the receiving surface 43, the magnitude of the bending moment with the boundary portion 32 being as a fulcrum is smaller than that in the comparative example. The depth of the cutout portion 60 in the Y-direction is preferably equal to or greater than a thermal deformation amount of the housing 10 so that the spaced surface 34 does not come into contact with the receiving surface 43, and is preferably equal to or greater than 0.1 mm, for example.

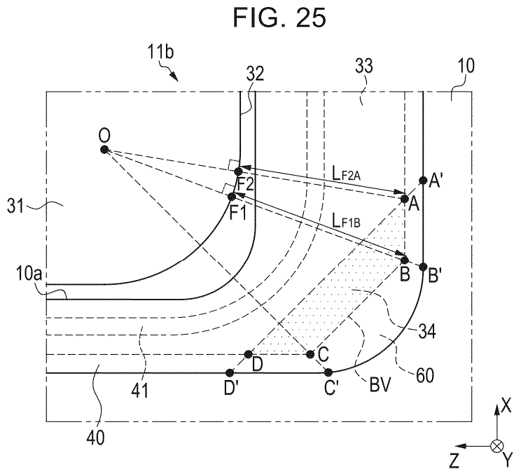

FIG. 25 shows the configuration in which the housing 10 and the corner portion 11b of the electrically insulating plate 11 are viewed from below. The spaced surface 34 is formed between the chamfered portion BV and a region corresponding to the groove 41. The spaced surface 34 has a shape with four vertices. For example, the spaced surface 34 is quadrilateral.

In FIG. 25, A to D represent imaginary points located at the end portion of the outer edge portion 30a of the electrically insulating plate 11. In the present embodiment as well, the region surrounded by the imaginary points A to D is the spaced surface 34. In the present embodiment, the line segment AD and the line segment BC are parallel, but may be non-parallel. The shape of the spaced surface 34 can be modified in a similar manner as in the first embodiment. That is, the spaced surface 34 is not limited to trapezoidal, and may be quadrilateral other than trapezoidal.

Points at which an extension line of the line segment AD and the end portion of the receiving portion 40 intersect with each other are defined as A′ and D′, a point at which an extension line of a line segment OB and the end portion of the receiving portion 40 intersect with each other is defined as B′, and a point at which an extension line of the line segment OC and the end portion of the receiving portion 40 intersect with each other is defined as C′. The cutout portion 60 is a region surrounded by A′, B′, C′, D′.

### 3.2 Effect

In the present embodiment, similarly to the first embodiment, the spaced surface 34 is formed on the electrically insulating plate 11. Accordingly, the longest distance between the boundary portion 32 and the Z-direction end of the contact surface 33 changes from the distance L_{F1B} between the intersection point F1 and the imaginary point B to the distance LF2A between the intersection point F2 and the imaginary point A. The same applies to the relationship between the imaginary point D and the imaginary point C. As described above, in the present embodiment, by providing the spaced surface 34, the distance between the boundary portion 32 and the end portion of the contact surface 33 is reduced, so that the bending moment generated at the boundary portion 32 is reduced. This suppresses occurrence of cracks and extends the lifetime of the electrically insulating plate 11.

### 3.3 Modification of Second Embodiment

Various modifications of the second embodiment will be described below.

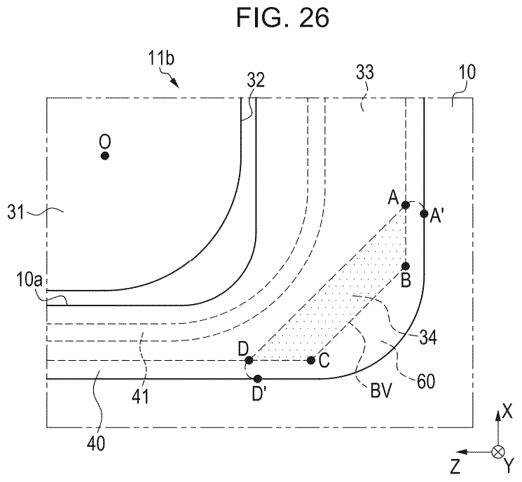

In the above embodiment, each of a line segment AA′ and a line segment DD′ being a part of the planar shape of the cutout portion 60 is a straight line, but as shown in FIG. 26, the line segment AA′ and the line segment DD′ may each be curved.

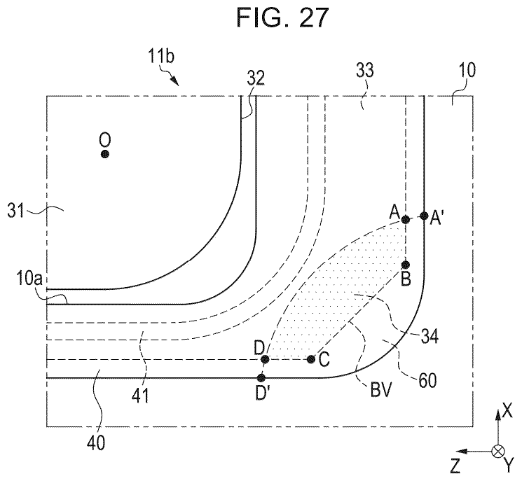

Further, in the above embodiment, the line segment AD being a part of the planar shape of the cutout portion 60 is a straight line, but as shown in FIG. 27, the line segment AD may be convexly curved toward the center point O as a whole. In this case, the line segment AD may have an arc shape having the same curvature as that of the boundary portion 32. Further, similarly to FIG. 26, the line segments AA', DD′ may be curved.

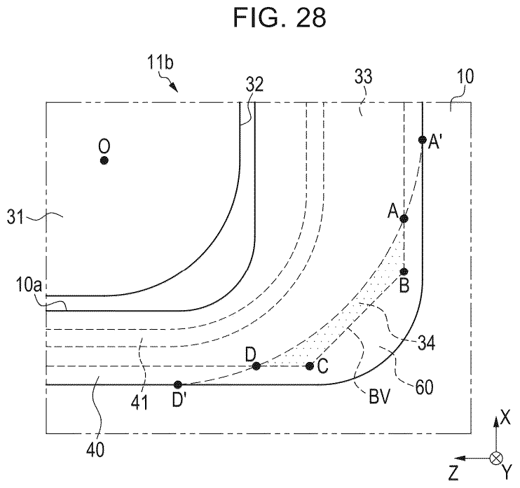

Further, as shown in FIG. 28, the line segment AD may be concavely curved toward the center point O as a whole. More specifically, the line segment AD may have an arc shape centered on the center point O. In this case, since the distance L between the boundary portion 32 and the line segment AD becomes equal at any position at the corner portion 11b, the stress applied to the boundary portion 32 at the corner portion 11b becomes uniform. As a result, stress concentration is suppressed, and thus damage to the boundary portion 32 is further suppressed. Further, similarly to FIG. 26, the line segments AA', DD′ may be curved.

Further, although the cutout portions 60 are formed at all of the regions corresponding to the four corner portions 11b in the above embodiment, it is sufficient to form the cutout portion 60 at a region corresponding to at least one corner portion 11b.

### 4. Electronic Device Manufacturing Method

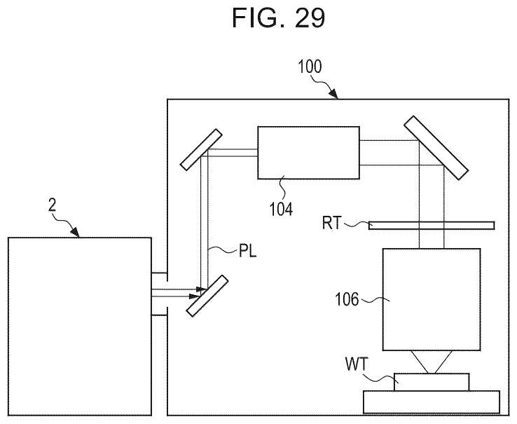

FIG. 29 schematically shows a configuration example of the exposure apparatus 100. The exposure apparatus 100 includes an illumination optical system 104 and a projection optical system 106. For example, the illumination optical system 104 illuminates a reticle pattern of a reticle (not shown) arranged on a reticle stage RT with the pulse laser light PL generated by the gas laser device 2 and incident from the gas laser device 2. The projection optical system 106 causes the pulse laser light PL transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the pulse laser light PL reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure.

Here, not limited to the manufacturing of an electronic device, the gas laser device 2 may be used for laser processing such as drilling.

The description above is intended to be illustrative and the present disclosure is not limited thereto. Therefore, it would be obvious to those skilled in the art that various modifications to the embodiments of the present disclosure would be possible without departing from the spirit and the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of the any thereof and any other than A, B, and C.

What is claimed is:

1. A chamber device comprising:
a metal housing having an opening through which a laser gas and a discharge electrode are stored, the opening having an end portion that has a stepped shape over an entire circumference thereof;
a ceramic electrically insulating plate having a planar shape surrounded by two sets of opposed straight edges and four corner portions, and having a stepped end portion that is fitted with the end portion of the opening around an entire circumference so as to cover the opening;
a pressing member pressing the two sets of opposed straight edges against the end portion of the opening while the four corner portions are exposed;
a groove formed to surround the opening on a receiving surface that receives the end portion of the electrically insulating plate at the end portion of the opening; and
an O-ring arranged in the groove,
a surface of the end portion of the electrically insulating plate facing the receiving surface including, at at least one of the four corner portions, a contact surface that is in contact with the receiving surface and covers the groove, and a spaced surface that is spaced apart from the receiving surface on an outer peripheral side with respect to the contact surface.

2. The chamber device according to claim 1,
wherein the surface of the end portion of the electrically insulating plate facing the receiving surface includes, at each of the four corner portions, the contact surface and the spaced surface.

3. The chamber device according to claim 1,
wherein the contact surface and the spaced surface are each planar, and a distance between the contact surface and the spaced surface is constant.

4. The chamber device according to claim 1,
wherein a chamfered portion is formed at at least one of the four corner portions by cutting off the end portion of the electrically insulating plate.

5. The chamber device according to claim 4,
wherein the spaced surface has a shape having four vertices with the chamfered portion being one side.

6. The chamber device according to claim 5,
wherein the spaced surface is quadrilateral.

7. The chamber device according to claim 6,
wherein the spaced surface is trapezoidal.

8. The chamber device according to claim 1,
wherein the electrically insulating plate is rectangular without chamfered portions formed.

9. The chamber device according to claim 8,
wherein the spaced surface has a shape with three vertices.

10. The chamber device according to claim 9,
wherein the spaced surface is a right-angled triangle or a right-angled isosceles triangle.

11. The chamber device according to claim 1,
wherein a distance between the contact surface and the spaced surface increases toward an outer peripheral side.

12. The chamber device according to claim 1,
wherein the spaced surface is formed by partially cutting off a region of the housing corresponding to at least one of the four corner portions.

13. The chamber device according to claim 1,
wherein the electrically insulating plate includes a base portion and an electrode fixing portion having a smaller planar shape than the base portion, and
the electrode fixing portion is arranged on an inner side of the housing with respect to the base portion.

14. The chamber device according to claim 13,
wherein the contact surface and the spaced surface are formed at an outer edge portion of the base portion that protrudes outward from the electrode fixing portion.

15. The chamber device according to claim 14,
wherein the housing is formed with a receiving portion protruding inward from an inner wall thereof, and the receiving surface is formed in the receiving portion.

16. A gas laser device comprising:
a chamber device, a pulse power module, and a charger,
the chamber device including:
a metal housing having an opening through which a laser gas and a discharge electrode are stored, the opening having an end portion that has a stepped shape over an entire circumference thereof;
a ceramic electrically insulating plate having a planar shape surrounded by two sets of opposed straight edges and four corner portions, and having a stepped end portion that is fitted with the end portion of the opening around an entire circumference so as to cover the opening;
a pressing member pressing the two sets of opposed straight edges against the end portion of the opening while the four corner portions are exposed;
a groove formed to surround the opening on a receiving surface that receives the end portion of the electrically insulating plate at the end portion of the opening; and
an O-ring arranged in the groove,
a surface of the end portion of the electrically insulating plate facing the receiving surface including, at at least one of the four corner portions, a contact surface that is in contact with the receiving surface and covers the groove, and a spaced surface that is spaced apart from the receiving surface on an outer peripheral side with respect to the contact surface,
the pulse power module being connected to the discharge electrode via a plurality of feedthroughs embedded in the electrically insulating plate; and
the charger being configured to supply a voltage to the pulse power module.

17. An electronic device manufacturing method, comprising:
generating laser light using a gas laser device;
outputting the laser light to an exposure apparatus; and
exposing a photosensitive substrate to the laser light in the exposure apparatus to manufacture an electronic device,
the gas laser device including a chamber device, a pulse power module, and a charger,
the chamber device including:
a metal housing having an opening through which a laser gas and a discharge electrode are stored, the opening having an end portion that has a stepped shape over an entire circumference thereof;
a ceramic electrically insulating plate having a planar shape surrounded by two sets of opposed straight edges and four corner portions, and having a stepped end portion that is fitted with the end portion of the opening around an entire circumference so as to cover the opening;
a pressing member pressing the two sets of opposed straight edges against the end portion of the opening while the four corner portions are exposed;
a groove formed to surround the opening on a receiving surface that receives the end portion of the electrically insulating plate at the end portion of the opening; and
an O-ring arranged in the groove,
a surface of the end portion of the electrically insulating plate facing the receiving surface including, at at least one of the four corner portions, a contact surface that is in contact with the receiving surface and covers the groove, and a spaced surface that is spaced apart from the receiving surface on an outer peripheral side with respect to the contact surface,
the pulse power module being connected to the discharge electrode via a plurality of feedthroughs embedded in the electrically insulating plate; and
the charger being configured to supply a charge voltage to the pulse power module.
